(19) United States
(12) Patent Application Publication
(10) Pub. No.: US 2025/0077444 A1
(43) Pub. Date: Mar. 6, 2025

(54) POST-SEND SUBMISSION COALESCING

(71) Applicant: NVIDIA Corporation, Santa Clara, CA (US)

(72) Inventors: Pak Markthub, Tokyo (JP); James Dinan, Westford, MA (US)

(21) Appl. No.: 18/627,981

(22) Filed: Apr. 5, 2024

Related U.S. Application Data
(60) Provisional application No. 63/534,925, filed on Aug. 28, 2023.

(51) Int. Cl. G06F 13/16; G06F 9/50

(52) U.S. Cl. CPC G06F 13/1642; G06F 9/5038; G06F 2209/5018

(57) ABSTRACT

A system is described having an input/output (IO) device and a processing unit coupled with the IO device. The processing unit is enabled to elect a thread from among a plurality of threads to atomically update a queue head pointer, uses the queue head pointer to reserve space in a plurality of memory registers for work queue elements belonging to the plurality of threads, and submit the work queue elements to the IO device.

### CROSS-REFERENCE TO RELATED APPLICATION

The present application claims the benefit of and priority, under 35 U.S.C. § 119, to U.S. Provisional Application Ser. No. 63/534,925, filed Aug. 28, 2023, entitled “POST-SEND SUBMISSION COALESCING” the entire disclosure of which is hereby incorporated herein by reference, in its entirety, for all that it teaches and for all purposes.

### FIELD OF THE DISCLOSURE

The present disclosure is generally directed to systems, methods, and devices for transmitting data between nodes and, in particular, toward improving asynchronous kernel-initiated communications.

### BACKGROUND

In modern high-performance computing systems, communication between computing devices is typically facilitated by a network of interconnected nodes. Each computing device, which may contain a central processing unit (CPU), a graphics processing unit (GPU), and/or other hardware peripheral, can be considered a node in the network. Data is transmitted between such nodes in a series of discrete operations, with each node serving as a relay point for the data. This structure enables parallel processing and data sharing, significantly improving overall system performance and enabling complex computational tasks. Communication between nodes is governed by various protocols, which can vary depending on the specific requirements of the system and the type of devices involved.

The concept of queue pairs (QPs) supports efficient operation of these inter-network communications. A QP is composed of a work queue including a send queue and a receive queue, acting as endpoints for data transmission between nodes. The send queue holds instructions for outgoing data, while the receive queue accommodates incoming data instructions. QPs also require completion queues which signal the completion of work requests posted to the work queue. The use of QPs enables network technologies such as InfiniBand to provide high-speed, low-latency communication between nodes. The implementation and management of QPs, however, can be complex, necessitating detailed handling of data transmission protocols and error management.

Latency and memory consumption are key factors in the performance and efficiency of these communication networks. Latency refers to the delay experienced during data transmission between nodes, which can impact the overall performance in real-time or high-speed applications. Memory consumption on the other hand relates to the amount of memory resources utilized for data transmission and processing. High memory consumption can lead to inefficiencies, potentially slowing down other processes and limiting the overall system performance. Optimizing both latency and memory consumption is therefore a continuous challenge in the development and operation of high-performance computing systems. Various strategies and technologies are employed to tackle these issues, aiming to deliver fast, efficient, and reliable communication between devices.

Technical shortcomings of conventional computing system networks relating to memory consumption and latency negatively affect real-world applications involving, for example, artificial intelligence models, mathematical calculations, and other computationally-complex applications.

### SUMMARY

In some communication protocols, such as an MLX5 post-send protocol, work queue entry (WQE) submission involves enqueueing a WQE into a ring buffer and updating the head pointer to submit work to a network interface card (NIC) or similar type of Input/Output (IO) device. In particular, a post-send protocol may include: (1) writing the WQE (or WQEs) in a work queue (WQ) buffer; (2) updating the doorbell record (DBR); and ringing the doorbell (DB).

In the GPUDirect Async-Kernel Initiated networking protocol (GDA-KI), WQ and DBR are in GPU memory. The DB is usually provided on the NIC. In CPU-centric libraries such as libibverbs, WQ and DBR are in host memory and the DB is on the NIC.

This is an inherently sequential process as it was designed for use by CPUs. Communication protocols such as GDA-KI, which utilize GPUs instead of CPUs, leverage a GPU streaming multiprocessor (SM) to submit WQEs to the NIC. If traditional WQE submission algorithms are strictly followed, the GPU will need to (1) lock the network QP, which limits the concurrency, or (2) create one QP per thread, which may consume hundreds GB of GPU memory in real applications. In addition, each WQE submission will require issuing a memory barrier, which incurs significant latency for the GPU SMS.

Ideally, multiple threads (from the same or different thread blocks (CTAs)) should be able to create WQEs in parallel and submit them to the same QP without locking. Also, the number of issued memory barriers should be reduceable (e.g., by issuing one memory barrier for submitting multiple WQEs).

Embodiments of the present disclosure aim to improve communication efficiencies by increasing the parallelism of the process described above for threads within the same thread block. Embodiments of the present disclosure further contemplate improving communication efficiencies while working within the framework of existing post-send protocol(s). Aspects of the present disclosure may include two levels: (1) warp-level coalescing of WQE slot reservation and WQE creation and (2) coalescing of memory barriers and doorbell updates.

Embodiments of the present disclosure are contemplated for use in an architecture having a scalable array of multithreaded SMs. Each SM may include a set of execution units, a set of registers, and a chunk of shared memory. In some embodiments, the basic unit of execution for a processing unit (e.g., a CPU or GPU) may be referred to as a warp. A warp may correspond to a collection of threads (e.g., 32 threads may belong to a warp) that are executed simultaneously by an SM. Multiple warps can be executed on an SM at once. When a program on a host CPU invokes a kernel grid, the blocks of the grid may be enumerated and distributed to SMs with available execution capacity. The threads of a thread block execute concurrently on one SM, and multiple thread blocks can execute concurrently on one SM. As thread blocks terminate, new blocks are launched on the vacated SMs. The mapping between warps and thread blocks can impact the performance of the kernel.

While embodiments of the present disclosure will be described in connection with an architecture having a scalable array of multithreaded SMs, it should be appreciated that features depicted and described herein can be utilized in other architectures. Specifically, but without limitation, embodiments of the present disclosure can be deployed in any computing architecture in which threads issue WQE slot reservation and/or WQE creation instructions/requests.

As mentioned above, one aspect of the present disclosure is to reduce the number of WQE submissions within each warp and is not targeted at reducing the overall number of WQEs. This approach elects a thread from those present in the warp to atomically update the QP head pointer to reserve space for WQEs from all present threads. Once the space has been reserved, threads can create WQEs in parallel and a single submitter thread is selected to submit the WQEs to the IO device. Algorithms or approaches depicted and described herein may be used by some or all threads within a warp.

Another aspect of the present disclosure is to coalesce WQE submissions. In some embodiments, WQE submissions may be coalesced from multiple submitted threads. An advantage offered by such coalescing is that the number of memory barriers needed can be reduced. In some approaches, a scenario is handled where: (1) a QP is dedicated to a CTA, and (2) a QP is shared among CTAs differently.

Prior approaches use the sequential algorithm described above and may create many QPs to obtain parallelism. However, creating many QPs consumes significant amounts of memory and may also lead to poor performance.

In contrast, the approach described herein provides at least the following advantages: leverage parallelism of GPU to create multiple WQEs concurrently; opportunistically and automatically reduce the number of memory barriers that need to be issued; reduce the scope of locking to between updating doorbell record (DBR) and writing to a doorbell (DB). This locking can be completely removed if the IO device supports DBR-less QP. Yet another advantage offered by the approaches described herein is that the coalescing causes only a few threads to wait on the lock. Other threads are freed to do other important tasks, rather than also wait.

Approaches described herein are useful when the processing unit (e.g., GPU) is interacting with any IO device that uses a similar command submission mechanism like the NIC mechanism described above. It can be viewed generically as a technique for coalescing entries when multiple threads on the processing unit enqueue entries into a circular buffer in memory.

In view of the above, one or more of the following are contemplated:

One aspect of the present disclosure is to provide a system that includes: an input/output (IO) device; and a processing unit coupled with the IO device, where the processing unit: elects a thread from among a plurality of threads to atomically update a queue head pointer; uses the queue head pointer to reserve space in a plurality of memory registers for work queue elements belonging to the plurality of threads; and submits the work queue elements to the IO device.

In some embodiments, the work queue elements are submitted to the IO device by a single submitter thread.

In some embodiments, the single submitter thread is the same as the thread elected from among the plurality of threads.

In some embodiments, the single submitter thread is different from the thread elected from among the plurality of threads.

In some embodiments, the IO device includes a Network Interface Card (NIC).

In some embodiments, the processing unit includes at least one of a Graphics Processing Unit (GPU), a Central Processing Unit (CPU), and a Data Processing Unit (DPU).

In some embodiments, a first thread is elected to submit the work queue elements, where ownership of submitting the work queue elements is transferred from the first thread to a second thread, and where the first thread is still enabled to submit a pending work request in response to a predetermined amount of time elapsing even after the ownership of submitting the work queue elements has been transferred to the second thread.

In some embodiments, a communication library is used to determine whether a queue pair is dedicated to a particular thread or is shared among the plurality of threads prior to allocating memory for the plurality of threads.

In some embodiments, the processing unit coalesces two or more work queue element submissions from different threads and allocates memory to the two or more work queue element submissions and the threads associated therewith.

In some embodiments, the processing unit checks whether a queue pair associated with a first submission and a queue pair associated with a second submission are shared between a common manager unit from the processing unit.

In some embodiments, the processing unit issues a single work queue element write back to the IO device for both the first submission and the second submission if all threads associated with the first submission and the second submission are shared between the common manager unit.

In some embodiments, the processing unit further enables the plurality of threads to create respective work requests in parallel with one another.

Another aspect of the present disclosure is to provide a method that includes: electing, at a processing unit, a thread from among a plurality of threads to atomically update a queue head pointer; using the queue head pointer to reserve space in a plurality of memory registers for work queue elements belonging to the plurality of threads; and submitting, from the processing unit to an input/output (IO) device, the work queue elements.

In some embodiments, a first thread is elected to submit the work queue elements, where ownership of submitting the work queue elements is transferred from the first thread to a second thread, and where the first thread is still enabled to submit a pending work request in response to a predetermined amount of time elapsing even after the ownership of submitting the work queue elements has been transferred to the second thread.

In some embodiments, the method further includes: determining whether a queue pair is dedicated to a particular thread or is shared among the plurality of threads prior to allocating memory.

In some embodiments, the method further includes: checking whether a queue pair associated with a first submission and a queue pair associated with a second submission are shared between a common manager unit from the processing unit; and issuing a single work queue element write back to the IO device for both the first submission and the second submission if all threads associated with the first submission and the second submission are shared between the common manager unit.

Another aspect of the present disclosure is to provide a device that includes: a processing unit in communication with an input/output (IO) device, where the processing unit supports multiple threads and enables the multiple threads to create work queue elements in parallel and then submit the work queue elements to a common queue pair without requiring a locking of the common queue pair.

In some embodiments, the processing unit atomically updates a queue head pointer using an elected thread from the multiple threads.

In some embodiments, the queue head pointer reserves space from memory registers for the multiple threads.

In some embodiments, a first thread is elected to submit the work queue elements, where ownership of submitting the work queue elements is transferred from the first thread to a second thread, and where the first thread is still enabled to submit a pending work request in response to a predetermined amount of time elapsing even after the ownership of submitting the work queue elements has been transferred to the second thread.

Additional features and advantages are described herein and will be apparent from the following Description and the figures.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

The present disclosure is described in conjunction with the appended figures, which are not necessarily drawn to scale:

FIG. 1 is a block diagram of a computing architecture used in accordance with one or more of the embodiments described herein;

FIG. 2 is a block diagram of a system in accordance with one or more of the embodiments described herein;

FIG. 3 is a block diagram of system components and interactions therebetween in accordance with one or more of the embodiments described herein;

FIG. 4 is a block diagram of a WQ buffer and an approach for coalescing WQE slot reservation requests in accordance with one or more of the embodiments described herein;

FIG. 5 is a block diagram of a mechanism for coalescing memory barriers and doorbell updates in accordance with one or more of the embodiments described herein;

FIG. 6 is a flow diagram illustrating a first method in accordance with one or more of the embodiments described herein;

FIG. 7 is a flow diagram illustrating a second method in accordance with one or more of the embodiments described herein; and

FIG. 8 is a flow diagram illustrating a third method in accordance with one or more of the embodiments described herein;

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The details of one or more aspects of the disclosure are set forth in the accompanying drawings and the description below. Other features, objects, and advantages of the techniques described in this disclosure will be apparent from the description and drawings, and from the claims.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The preceding Summary is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages are described herein and will be apparent to those skilled in the art upon consideration of the following Detailed Description and in view of the figures.

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

It will be appreciated from the following description, and for reasons of computational efficiency, that the components of the system can be arranged at any appropriate location within a distributed network of components without impacting the operation of the system.

Further, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Any of the steps, functions, and operations discussed herein can be performed continuously and automatically.

The systems and methods of this disclosure have been described in relation to a network of switches; however, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

References in the specification to “one embodiment,” “an embodiment,” “an example embodiment,” “some embodiments,” etc., indicate that the embodiment described may include a particular feature, structure, or characteristic, but every embodiment may not necessarily include the particular feature, structure, or characteristic. Moreover, such phrases may not necessarily refer to the same embodiment. Further, when a particular feature, structure, or characteristic is described in conjunction with one embodiment, it is submitted that the description of such feature, structure, or characteristic may apply to any other embodiment unless so stated and/or except as will be readily apparent to one skilled in the art from the description. The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The use of GPUs as a means to offload computationally-intensive tasks from CPUs and the use of networks of computing nodes to implement computationally-intensive tasks, whether executed by CPUs or GPUs, is increasingly important to users such as scientific researchers seeking to execute artificial intelligence (AI) models and other computationally-intensive processes. The growing demand for high-performance computing in various domains, including scientific simulations, machine learning, and image processing, has driven the need for efficient and cost-effective computational resources. The limitations of network communication performance and the increasing importance of parallelism have prompted researchers and other users to explore alternatives to the use of single computing devices for performing data processing. As a result, GPUs have emerged as an approach to offload computationally-intensive tasks from CPUs and networks of computing systems have become useful for executing complex processing applications.

Embodiments of the present disclosure may increase the message rate that GDA-KI can achieve by several folds (e.g., up to 36×). Embodiments of the present disclosure are useful when the GPU is interacting with any IO device that employs a similar command submission mechanism like the NIC mechanism(s) described herein. Aspects of the present disclosure provide a technique for coalescing entries when multiple threads on the GPU enqueue entries into a circular buffer in memory.

The systems and methods described herein may be used by computing systems in which a GPU communicates with GPUs of peers through NVSHMEM or other GPU-accelerated libraries. For example, embodiments of the present disclosure may include a GPU performing data packet preparation, scheduling, sending or transmission. Through such a system, workloads may be shifted from a CPU to computationally viable GPUs.

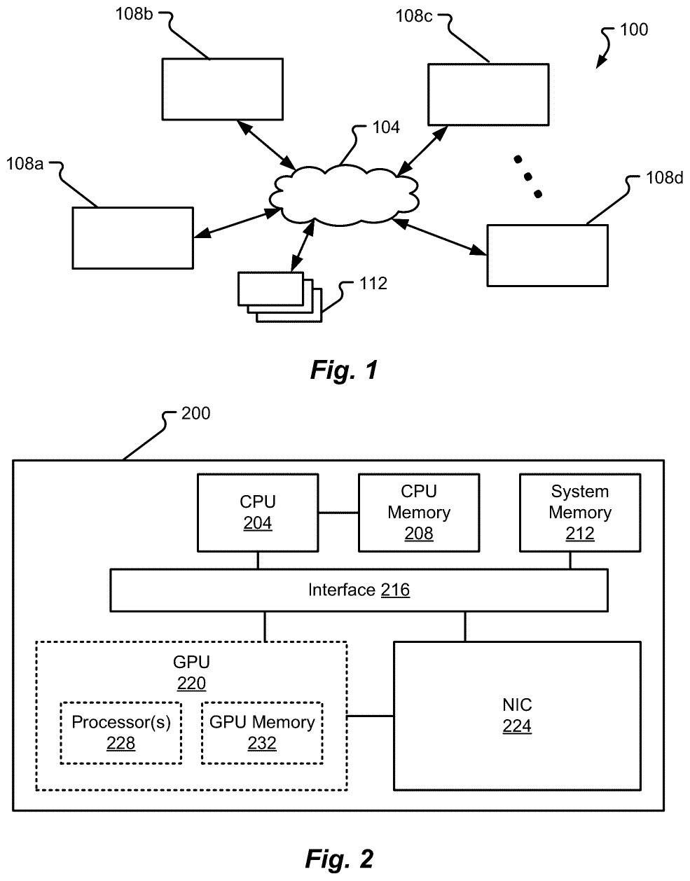

Reference is now made to FIGS. 1 and 2, in which a computing architecture 100 and system 200 are illustrated in accordance with one or more embodiments. The computing architecture 100 may include one or more peer computing systems 108a-d communicating with each other via a network 104.

Each of the one or more peer computing systems 108a-d may connect to each other as well as to other peer devices 112 to access shared resources, services, and data, via the network 104. The peer computing systems 108a-d may be, for example, client devices such as personal computers, laptops, smartphones, IoT devices, as well as switches or servers, or any type of computing system capable of sending data to and receiving data over a network 104.

Each of the peer devices 112 may comprise network interfaces including, for example, a transceiver. Some or all of the peer devices 112 may be capable of receiving and transmitting packets in conformance with applicable protocols such as TCP, although other protocols may be used. Peer devices 112 may also be configured to receive and transmit packets to and from network 104.

In some implementations, one or more peer computing systems 108a-d and devices 112 may be switches, proxies, gateways, load balancers, etc. Such systems 108a-d and devices 112 may serve as intermediaries between clients and/or servers, relaying or modifying the communication between the clients and/or servers.

In some implementations, one or more of the peer computing systems 108a-d and devices 112 may be IoT devices, such as sensors, actuators, and/or embedded systems, connected to the networks 104. Such IoT devices may act as clients, servers, or both, depending on implementations and the specific IoT applications. For example, a first peer computing system or device may be a smart thermostat acting as a client, while a second peer computing system or device may be a central server for analysis or a smartphone executing an app.

As should be appreciated, in the realm of high-performance computing, a myriad of peer computing systems 108a-d can utilize QPs and WQ buffers for network communication. For example, in server farms, data centers, or clusters used for big data analytics and scientific computing, CPUs and/or GPUs of a peer computing system 108a-d may use QPs and WQ buffers to send and receive data between each other, such as via protocols including InfiniBand or Ethernet.

A system 200 having one or more CPUs 204 and one or more GPUs 220 may correspond to an example of a peer computing system 108a-d and/or a peer device 112. The advent of general-purpose computing on GPU has led to widespread use of GPUs 220 for tasks beyond just rendering graphics, especially in fields like machine learning, deep learning, and data mining. GPUs 220 may be capable of handling thousands of threads simultaneously, making them well-suited for massively parallel tasks.

While the system 200 may be configured to communicate with other systems 200 over the network 104 as described herein, it should be appreciated that the systems 200 may also communicate with other peer computing systems 108a-d and/or peer devices 112, which may or may not utilize the network 104.

The network 104 illustrated in FIG. 1 may rely on various networking hardware and protocols to establish communication between the a peer computing system 108a-d and other peer computing systems 108a-d and/or peer devices 112. Such infrastructure may include one or more routers, switches, and/or access points, as well as wired and/or wireless connections. The network 104 may be, for example, a local area network (LAN) interconnecting peer computing systems 108a-d and peer devices 112. A LAN may use Ethernet or Wi-Fi technologies to provide communication between the peer computing systems.

In some implementations, the network 104 may be, for example, a wide area network (WAN) and may be used to connect peer computing devices 112 with one or more peer computing systems 108a-d. A WAN may comprise, for example, one or more of lines, satellite links, cellular networks. WANs may use various transmission technologies, such as leased lines, satellite links, or cellular networks, to provide long-distance communication. Transmission control protocol (TCP) communication over a WAN may be used, for example, to enable peer computing systems 108a-d to communicate reliably across vast distances. In some implementations, network 104 may comprise the Internet, one or more mobile networks, such as 4G, 5G, LTE, virtual networks, such as a VPN, or some combination thereof.

System 200, like the peer computing systems 108a-d, may be or include client devices and may encompass a wide range of devices, including desktop computers, laptops, smartphones, IoT devices, etc. Such systems 200 may execute one or more applications which communicate with other systems 200 to access resources or services. For example, a first system 200 may execute a web browser and a second system 200 may act as a web server. The first computing system 200 may communicate with the second system 200 to request and display web content. As another example, a first system 200 may execute a file-sharing application and a second system 200 may act as a file server. The first system 200 may communicate with the second system 200 to upload or download files. As another example, a first system 200 may act as an AI server capable of being used by a second system 200 to offload computationally-intensive processes for execution in parallel by one or more GPUs 220 of the first system 200. Applications running on the systems 200 may be responsible for initiating communication with other systems 200 making requests for resources or services, and processing data. The network 104 may enable the systems 200 to communicate any number of concurrent communications with any number of peer computing systems 108a-d and/or peer devices 112 simultaneously.

It should also be appreciated that in some embodiments, the systems and methods described herein may be executed without a network 104 connection. For example, one or more peer computing systems 108a-d (or systems 200) may be capable of communicating directly with other peer computing systems 108a-d (or systems 200) without relying on any particular network 104.

As illustrated in FIG. 2, each a system 200 may include one or more CPUs 204, one or more GPUs 220, and one or more NICs 224. Each of the CPUs 204, GPUs 220, and NICs 224 may communicate via an interface 216.

The NIC 224 may comprise one or more circuits capable of acting as an interface between components of the system 200, such as the CPU 204 and the GPU 220. The NIC 224 may also act as an interface between components of the system 200 and the network 104. The NIC 224 may enable data transmission and reception such that peer computing systems 108a-d may communicate with the system 200. A NIC 224 may comprise one or more of a peripheral component interconnect express (PCIe) card, a USB adapter, and/or may be integrated into a PCB such as a motherboard. The NIC 224 may be capable of supporting any number of network protocols such as Ethernet, Wi-Fi, fiber channel, etc.

As described herein, the NIC 224 may be capable of receiving packets from one or more peer computing systems 108a-d via the network 104. The NIC 224 may process a header of each received packet to determine whether each packet should be handled by the CPU 204 or the GPU 220. In some implementations, the NIC 224 may be in direct communication with each of the GPU(s) 220 and the CPU(s) 204 via the interface 216 as well as in external communication with the network 104 via, for example, Ethernet in combination with TCP.

One or more CPUs 204 of the system 200 may each comprise one or more circuits capable of executing instructions and performing calculations. The CPUs 204 may be capable of interpreting and processing data received by the system 200 via the NIC 224. CPUs 204 of a system 200 may each comprise one or more arithmetic logic units (ALUs) capable of performing arithmetic and/or logical operations, such as addition, subtraction, and bitwise operations. The CPUs 204 may also or alternatively comprise one or more control unit (CUs) which may be capable of managing the flow of instructions and data within the CPU 204. CUs of the CPU 204 may be configured to fetch instructions from CPU memory 208 or system memory 212, decode the instructions, and direct appropriate components to execute operations based on the instructions.

A CPU 204 of the system 200 may include, for example, a reduced instruction set computing (RISC) processor, a complex instruction set computing (CISC) processor, a digital signal processor (DSP) such as a baseband processor, an application-specific integrated circuit (ASIC), a field-programmable gate array (FPGA), a radio-frequency integrated circuit (RFIC), another processor (including those discussed herein), or any suitable combination thereof. Similarly, a GPU 220 as described herein may include a processor 228 such as a streaming multiprocessor (SM), a RISC processor, a CISC processor, a DSP, a baseband processor, an ASIC, an FPGA, an RFIC, another processor (including those discussed herein), or any suitable combination thereof.

A CPU 204 and/or a processor 228 of a GPU 220 as described herein may incorporate multiple processing cores, allowing the CPU 204 (and/or the GPU 220) to execute multiple instructions simultaneously, and/or may be capable of performing hyperthreading to execute multiple threads concurrently.

One or more GPUs 220 of the system 200 may each comprise one or more circuits capable of acting as specialized processing components to handle computationally-intensive tasks, such as rendering graphics and performing complex mathematical calculations. GPUs 220 may be capable of parallel execution of general-purpose tasks alongside the CPUs 204.

As noted above, a GPU 220 may comprise one or more streaming multiprocessors (SMs), CUs, or processors 228, which may be responsible for executing instructions in parallel. Each SM, CU, or processor 228 of a GPU 220 may contain one or more processing cores or ALUs which may be capable of performing arithmetic and/or logical operations concurrently.

One, some, or all GPUs 220 of the system 200 may be capable of executing tasks such as scientific simulations, machine learning, and data analysis. For example, a GPU 220 of the system 200 may be designed for operation in workstation environments, such as for performing scientific simulations, executing and/or training machine learning models, performing data analysis, etc.

The GPU 220 may execute one or more kernels. Kernels executed by the GPU 220 may perform specific, parallelizable tasks on the GPU 220. Such kernels may be written using GPU programming languages or frameworks, such as CUDA.

The interface 216 of the system 200 may comprise one or more circuits capable of connecting peripheral devices such as the NIC 224, one or more GPUs 220, and one or more CPUs 204 to a motherboard of the system 200, as well as one or more devices used for system memory 212. The interface 216 may comprise one or more high-speed lanes. Each lane may be, for example, a serial lane, and may consist of a pair of signaling wires for transmitting and/or receiving data. The interface 216 may be, for example, a PCIe bus.

The device(s) used for system memory 212 may include solid-state drives (SSDs), such as NVMe SSDs. The system memory 212 may be capable of providing fast and efficient data access and storage. Each of the CPU 204, GPU 220, and NIC 224 may be capable of sending data to and reading data from the system memory 212 via the interface 216. Each of the CPU 204, GPU 220, and NIC 224. Illustratively, but without limitation, the CPU 204 may have access to dedicated CPU memory 208 and the GPU 220 may have one or more devices dedicated to GPU memory 232.

The disclosed systems and methods may be adaptable and usable for both systems with and without GPUs 220. As described above, embodiments of the present disclosure may include a GPU 220 performing data packet preparation, scheduling, sending, and/or transmission. In some embodiments, the CPU 204 may instruct the GPU 220 (or multiple GPUs 220) to perform various tasks. Such platforms may employ GPU accelerated signal processing, such as by using GDA-KI to enable the GPU 220 to prepare network work descriptors or WQEs and submit such descriptors to the NIC 224.

Because the CPU 204 and GPU 220 may have different memory spaces, data that is processed by the GPU 220 is moved from the CPU 204 to the GPU 220 before the computation starts, and the results of the computation are moved back to the CPU 204 once processing has completed. The system memory 212, on the other hand, represents global memory that is accessible to all threads as well as the host (e.g., the CPU 204). Global memory is allocated and deallocated by the host and may be used to initialize the data that the GPU 220 will work on.

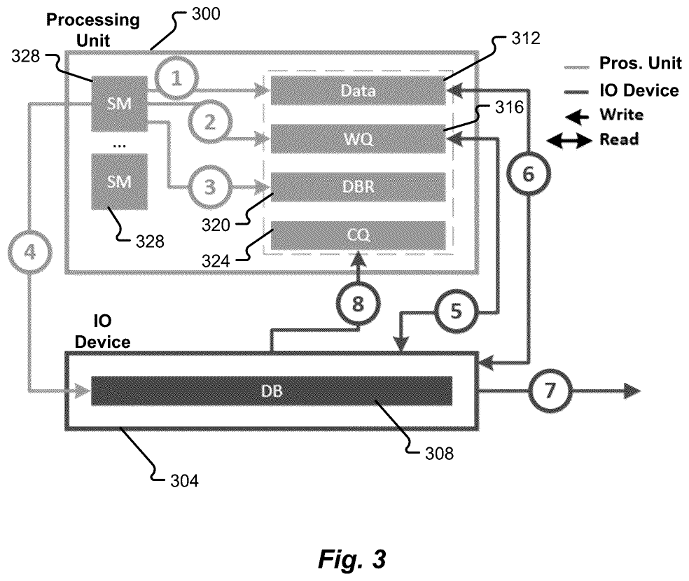

Referring now to FIG. 3, additional details of a processing unit 300 interacting with an IO device 304 will be described in accordance with at least some embodiments of the present disclosure. A CPU 204 and/or GPU 220 may correspond to examples of a processing unit 300. Other examples of a processing unit 300 include, without limitation, a DPU, a microprocessor, a collection of CPUs 204, a collection of GPUs 220, a collection of DPUs, a collection of microprocessors, and the like.

A NIC 224 may correspond to an example of an IO device 304. It should be appreciated that embodiments of the present disclosure may apply to other queue-based producer-consumer models, such as the NVMe submission queue. In this context, an IO device 304 may correspond to a different type of device, such as a memory device.

The processing unit 300 is illustrated to include a plurality of SMs 328. Within the context of the processing unit 300, the basic unit of execution may be referred to as a warp. A warp is a collection of threads that are executed simultaneously by an SM 328. Multiple warps can be executed on an SM 328 at once.

When a program on the processing unit 300 invokes a kernel grid, the blocks of the grid are enumerated and distributed to SMs 328 with available execution capacity. The threads of a thread block execute concurrently on one SM 328, and multiple thread blocks can execute concurrently on one SM 328. As thread blocks terminate, new blocks may be launched on the vacated SMs 328.

The mapping between warps and thread blocks can affect the performance of the kernel. Mapping can be achieved by assigning identifiers (IDs) to threads (e.g., a thread ID) and by using an index of a thread. The index of a thread and its thread ID relate to each other as follows: for a 1-dimensional block, the thread index and thread ID are the same; for a 2-dimensional block, the thread index (x,y) has thread ID=x+yDx, for block size (Dx,Dy); for a 3-dimensional block, the thread index (x,y,x) has thread ID=x+yDx+zDxDy, for block size (Dx,Dy,Dz).

When a kernel is started, the number of blocks per grid and the number of threads per block are fixed (gridDim and blockDim). The processing unit 300 makes four pieces of information available to each thread: (1) the thread index (threadIdx); (2) The block index (blockIdx); (3) the size and shape of a block (blockDim); and (4) the size and shape of a grid (gridDim).

The processing unit 300 may transfer data 312 to the IO device 304 and/or receive data 312 from the IO device 304 using the WQ 316, the DBR 320, and a completion queue (CQ) 324. The WQ 316, DBR 320, and CQ 324 may enable the SMs 328 of the processing unit 300 to interact directly with the IO device 304.

WQs 316 may be used to hold WQEs, which represent operations to be performed. The WQ 316 may operate as a repository for WQEs. Each WQE in the WQs 316 may contain information about the operation such as the type of operation, the location of the data, and other control information. Thus, each WQ 316 consumes memory for every WQE it holds, impacting the overall memory consumption of a QP.

CQs 324 may be utilized to track a completion status of WQEs. When an operation associated with a WQE is completed, a completion event may be generated and placed into a CQ 316. A QP may be associated with one or more CQs 324. Therefore, for each QP, memory may be consumed for the storage of completion events within these CQs 324.

DBRs 320 may be used as a notification mechanism when new WQEs are put on the WQs 316 or to solicit completion notifications from the CQs 324. Each QP may be associated with a corresponding DBR.

In operation, the processing unit 300 may interact with the IO device 304 according to a series of operations (1)-(8). In a first operation (1), an application launches a kernel that produces data in the memory of the processing unit. The memory of the processing unit may include CPU memory 208, GPU memory 232, and/or system memory 212. This operation may be viewed as an operation that locks a QP.

In a second operation (2), the application calls an operation (e.g., nvshmem_put) to communicate with another device (e.g., a peer computing system 108a-d, a peer device 112, IO device 304, etc.). In this step, an SM 328 is used to create a work descriptor. The work descriptor (e.g., WQE), may be written directly to the WQ 316 buffer. As mentioned above, the WQ 316 may reside directly on memory of the processing unit 300 (e.g., as CPU memory 208 and/or GPU memory 232). In some embodiments, this operation may be viewed as an operation in which one or a plurality of WQEs are created.

In a third operation (3), the SM 328 updates the DBR 320 buffer by creating a memory barrier. As noted above, the DBR 320 buffer may be on the memory of the processing unit 300, thereby making the DBR 320 buffer directly accessible to the SM 328.

In a fourth operation (4), the SM 328 notifies the IO device 304 of the WQE(s). This notification may be achieved by writing to the DB 308 register of the IO device 304.

In a fifth operation (5), the IO device 304 reads the WQE(s) in the WQ 316 buffer. This operation may be executed using a remote direct memory access (RDMA), in which the IO device 304 is able to access information stored in the WQ 316 buffer without involvement by the SM 328.

In a sixth operation (6), the IO device 304 reads that data 312 from the memory of the processing unit 300. The data 312 may also be read using RDMA or a similar approach. The location of the data 312 may be obtained, at least in part, with data retrieved from the corresponding WQE.

In a seventh operation (7), the IO device 304 may transfer the data 312 to a remote node. For instance, the IO device 304 may transfer the data 312 to a peer computing system 108a-d, a peer device 112, or the like.

In an eighth operation (8), the IO device 304 may notify the processing unit 300 that the operation is completed by writing to the CQ 324 buffer. RDMA may also be used to write to the CQ 324 buffer. At this point, a QP may be unlocked.

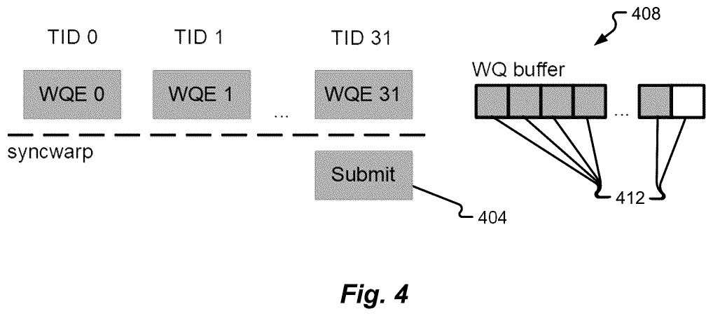

With the basic operations in mind, improvements involving warp-level coalescing of WQE slot reservations and WQE creations as well as coalescing of memory barriers and DBR updates will now be described. Referring initially to FIG. 4, details of achieving warp-level coalescing of WQE slot reservation and WQE creation will be described in accordance with at least some embodiments of the present disclosure.

The proposed solution aims at increasing the parallelism of the process described in connection with FIG. 3 for threads within the same CTA. Advantageously, the process described in connection with FIG. 3 does not necessarily have to be changed to support the improvements described herein. In this approach, the number of WQE submissions (e.g., WQE0-WQE 31) is reduced by electing a thread from those present in the warp to atomically update the QP head pointer to reserve space in the WQ buffer 408 (which may be similar or identical to WQ 316) for the WQEs 412 from all present threads. Once the space has been reserved in the WQ buffer 408, the threads can create WQEs 412 in parallel and a single submit thread 404 is selected to submit the WQEs 412 to the IO device 304. The IO device 304 is unaware that the WQEs 412 were coalesced and processes the WQEs 412 in the normal fashion, as described in connection with FIG. 3.

Further details of the WQE 412 coalescing may be understood with reference to the following pseudocode.

Code 1: WQE submission coalescing

| 1. | amask := _{——}activemask( ) | |
|---|---|---|
| 2. | if amask == FULL_WARP: | // all threads in the warp |
| | participates | |
| | a. my_tid = get_my_thread_id_in_warp( ) | |
| | b. tg_size = get_num_threads_in_warp( ) | |
| | c. num_slots = _{——}sum(amask, num_bb) | |
| 3. | else: | |
| | a. my_tid = 0 | |
| | b. tg_size = 1 | |
| 4. | if (my_tid == 0) | |
| | a. base_wqe_idx = atomicAdd(&wqe_head, num_slots) | |
| 5. | if (amask == FULL_WARP) | |
| | a. base_wqe_idx = _{——}shfl_sync(amask, base_wqe_idx, 0) | |
| 6. | my_wqe_idx = base_wqe_idx + my_tid * num_bb | |
| 7. | Create WQE[my_wqe_idx] | // all threads create WQEs in |

| | |
|---|---|
| | parallel |
| 8. | if (amask == FULL_WARP) _{——}sync_warp( ) |
| 9. | if (my_tid == tg_size − 1) submit_wqes(qp, |
| | &WQE[base_wqe_idx], base_wqe_idx, tg_size) |

As shown above, it may not be required to coalesce WQE submissions, meaning that the process works at least as efficiently as the process of FIG. 3. However, when opportunities exist to coalesce two or more WQE submissions, then computational improvements can be made relative to the process of FIG. 3. As noted above, this process may be utilized by some or all of the threads within a warp.

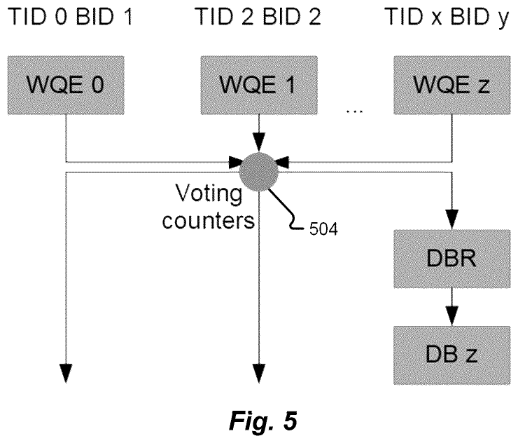

With reference now to FIG. 5, additional details related to coalescing WQE submissions from multiple submitter threads will be described. The process of FIG. 5 may be used alone or in combination with the process depicted and descried in connection with FIG. 4. Additional details of coalescing WQE submissions from multiple submitter threads may also be better understood with reference to the following pseudocode.

Code 2: Coalescing WQE submissions from multiple submitter threads

submit_wqes(qp_t *qp, void *wqe_ptr, base_idx, num_wqes)

| 1. | new_idx = base_idx + num_wqes | |
|---|---|---|
| 2. | if (is_qp_shared_between_ctas(qp)) | |
| | a. | // CUDA memory model requires us to call memory |
| | | barrier if we are using different CTAs. However, |
| | | we don't have to from the GPU architecture's |
| | | perspective. So, we can change this checking to |
| | | is_qp_shared_between_sm(qp) as well. |
| | b. | Memory barrier // Push my WQE writes to the point of |
| | | consistency before notifying other threads. This step is |
| | | unnecessary if all threads belong to the same CTA. |
| 3. | while (READ_ONCE(&submission_head) < base_idx) | |
| | a. | ; // wait here until all prior WQEs from other threads |
| | | are ready |
| 4. | if ((new_idx == READ_ONCE(&wqe_head)) \|\| (new_idx − | |
| | submission_tail >= threshold)) | |
| | // wqe_head is updated by item 4 of Code 1. This thread is still | |
| | the submitter and proceeds to submit the pending WQEs. | |
| | // We also check submission_tail and threshold and do | |
| | submission even if there is another thread that can submit for | |
| | us. The reason is that waiting for that thread (for coalescing) | |
| | will add latency. It is worth regularly submitting WQEs to the | |
| | NIC so that the NIC can start the processing rather than | |
| | waiting for more potential coalescing. | |
| | a. | submission_tail := new_idx |
| | b. | if (QP has DBR) |

| | |
|---|---|
| i. | Memory barrier |
| ii. | Update DBR |

| | |
|---|---|
| c. | Memory barrier |
| d. | Write DB |

| | |
|---|---|
| 5. | else |
| | // wqe_head advanced beyond new_idx, another thread will |
| | eventually enter submit_wqes. That thread can write DB and that |
| | will automatically submit the WQEs of this thread. |
| 6. | WRITE_ONCE(&submission_head, new_idx); |

The approach illustrated in FIG. 5 and highlighted in Code 2 handles scenarios where 1) a QP is dedicated to a CTA, and 2) a QP is shared among CTAs differently. A notable difference is the utilization of step 2.a when shared QPs are employed. From the perspective of the process, this difference is subtle. However, the difference delivers improved computational performance because the memory barrier is expensive compared to the rest of the post-send algorithm. Libraries that implement GDA-KI such as NVSHMEM have prior knowledge whether the QP is dedicated or shared. The libraries can choose the correct approach to gain maximum performance.

Step 4 of Code 2 also checks the “threshold” and does submission without waiting for further coalescing opportunities. The reasoning is that the submission latency can be very high when there are many threads producing WQEs 412 and entering Code 2. Without going to step 4.d, the IO device 304 could be idle since the IO device 304 does not normally read the WQ buffer 408 until it receives the DB signal. Accordingly, regularly submitting work to the IO device 304 is better than waiting for more coalescing. The approach illustrated in Code 2 and FIG. 5 provides a method using predetermined “threshold”, but it does not prevent use of a more sophisticated approach such as monitoring whether the IO device 304 is now idle or still busy.

Code 2 and FIG. 5 further illustrate the use of voting counters 504. Use of voting counters 504 and atomicAdd plus counter checking helps to avoid locking QPs. In this way, multiple threads can create WQEs 412 in parallel. One thread is then elected to submit all created WQEs 412 to the IO device 304. The other threads are thereby freed to exit the communication critical path, thereby enhancing performance.

The memory and/or storage devices of the system 200 may store instructions such as software, a program, an application, or other executable code for causing at least any of the CPU 204, the GPU 220, and the NIC 224 to perform, alone or in combination, any one or more of the methods discussed herein. The instructions may in some implementations reside, completely or partially, within at least one of the memory/storage devices illustrated in FIGS. 1-5, or any suitable combination thereof.

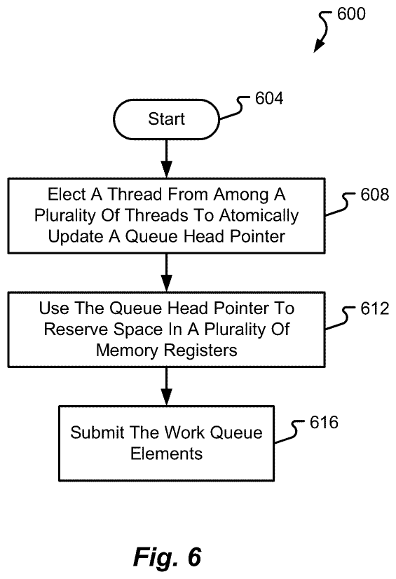

In some embodiments, the electronic device(s), network(s), system(s), chip(s), circuit(s), or component(s), or portions or implementations thereof, of FIGS. 1-5, or some other figure herein, may be configured to perform one or more processes, techniques, or methods as described herein, or portions thereof. Such processes may be as depicted in FIGS. 6-8 and as described below.

Referring now to FIG. 6, a first method 600 will be described in accordance with at least some embodiments of the present disclosure. The first method 600 may be performed alone or in combination with any other method described herein. Moreover, steps from other methods may be incorporated into the first method 600, and vice versa. The first method 600 may correspond to a method of improving computational performance by coalescing WQE submissions.

The method 600 may start with a start operation (step 604). Initiation of the method 600 may begin when one or more SMs 328 initiate the process of leveraging an IO device 304. In some embodiments, the SMs 328 of the processing unit 300 may submit WQEs to the IO device 304 as part of leveraging the IO device 304.

The method 600 may continue by electing a thread from among a plurality of threads to atomically update a queue head pointer (step 608). Electing a single thread from among a plurality of threads helps to improve efficiencies associated with WQE submission. In particular, if a submitter thread were not elected and each thread were left to follow its own WQE submission process, either (1) the network QP would have to be locked, thereby limiting concurrency or (2) each thread would have to create its own QP, which may consume hundreds of GB of memory from the processing unit 300. Selecting a single submitter thread for a plurality of threads helps to avoid these issues.

The method 600 may further continue by using the queue head pointer that was updated from the elected thread to reserve space in a plurality of memory registers in the WQ buffer 418 (step 612). The number of memory registers reserved by the elected thread may be dictated by the number of threads in the warp (e.g., the number of threads having the WQE submissions coalesced with the elected submitter thread) and the size required for each thread. In some embodiments, the number of WQE slots is determined at the time of coalescing based on the number of threads and the size required for each thread's WQE 412.

The method 600 continues with the elected submitter thread submitting the WQEs for all of the plurality of threads (step 616). This approach frees up the non-elected threads to create WQEs concurrently.

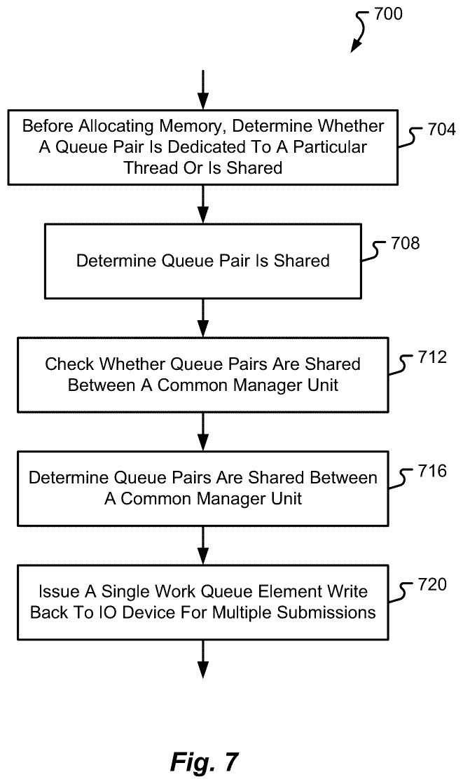

Referring now to FIG. 7, a second method 700 will be described in accordance with at least some embodiments of the present disclosure. The second method 700 may be performed alone or in combination with any other method described herein. Moreover, steps from other methods may be incorporated into the second method 700, and vice versa. The second method 700 may correspond to a method of improving computational performance by coalescing WQE writes.

The method 700 begins by determining whether a QP is dedicated to a particular thread or is shared among a plurality of threads before allocating memory to the QP (step 704). The method 700 may continue by determining that a QP is shared by two or more threads (step 708).

When it is determined that the QP is shared by two or more threads, the method 700 may continue by checking whether QPs are shared between a common manager unit (step 712). One example of a manager unit is the SM 328.

The method 700 may further continue when it is determined that QPs are shared with a common manager unit (step 716). In response to determining that two or more QPs are shared with a common manager unit, the method 700 continues by issuing a single WQE write back to the IO device 304 for the multiple WQE submissions (step 720). Coalescing WQE writes in this way helps to reduce the number of overall WQE writes and may improve interactions between the processing unit 300 and IO device 304.

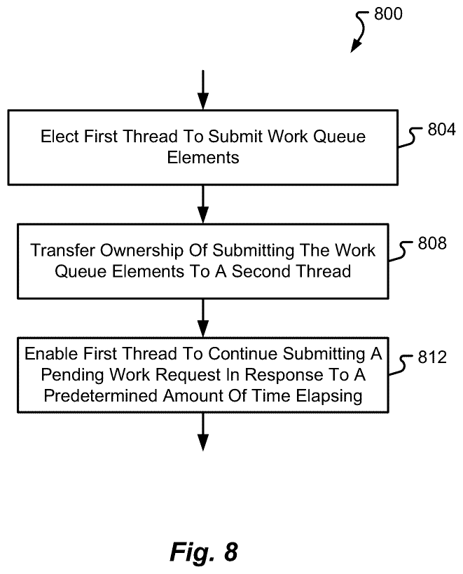

Referring now to FIG. 8, a third method 800 will be described in accordance with at least some embodiments of the present disclosure. The third method 800 may be performed alone or in combination with any other method described herein. Moreover, steps from other methods may be incorporated into the third method 800, and vice versa. The third method 800 may correspond to a method of improving computational performance by enabling parallelism and also transferring ownership of submitting WQEs from one thread to another.

The method 800 may begin by electing a first threads to submit one or more WQE (step 804). The first thread may be elected from a plurality of threads and the first thread may be elected to submit one, some, or all of the WQEs on behalf of the plurality of threads.

The method 800 may continue by transferring ownership of submitting the WQEs from the first thread to a second thread (step 808). The second thread may also belong to the plurality of threads from which the first thread was originally elected. Alternatively or additionally, the second thread may not have belonged to the plurality of threads from which the first thread was originally elected. In other words, the thread that is initially elected to submit WQEs can change in response to additional threads arriving and inserting WQEs into the WQ. In some embodiments, it may be possible to avoid a lock by passing mutual exclusion directly from one thread (e.g., the first thread) to a new thread (e.g., the second thread). This transfer may be achieved through the submission_head parameter.

Even if it is possible to handoff ownership of the WQE submission from one thread to another, the originally-elected thread (e.g., the first thread) may still be enabled to submit pending WQEs to the IO device 304 in response to a given time period having elapsed (step 812). In other words, an upper limit may be placed on how long a given WQE can be delayed to facilitate coalescing.

Aspects of the above systems and networking device include any one or more of the features as substantially disclosed herein in combination with any one or more other features as substantially disclosed herein.

Aspects of the above systems and networking device include any one of the aspects/features/embodiments in combination with any one or more other aspects/features/embodiments.

Aspects of the above systems and networking device include any use of any one or more of the aspects or features as disclosed herein.

It is to be appreciated that any feature described herein can be claimed in combination with any other feature(s) as described herein, regardless of whether the features come from the same described embodiment.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
an input/output (IO) device; and
a processing unit coupled with the IO device, wherein the processing unit:
elects a thread from among a plurality of threads to atomically update a queue head pointer;
uses the queue head pointer to reserve space in a plurality of memory registers for work queue elements belonging to the plurality of threads; and
submits the work queue elements to the IO device.

2. The system of claim 1, wherein the work queue elements are submitted to the IO device by a single submitter thread.

3. The system of claim 2, wherein the single submitter thread is the same as the thread elected from among the plurality of threads.

4. The system of claim 2, wherein the single submitter thread is different from the thread elected from among the plurality of threads.

5. The system of claim 1, wherein the IO device comprises a Network Interface Card (NIC).

6. The system of claim 1, wherein the processing unit comprises at least one of a Graphics Processing Unit (GPU), a Central Processing Unit (CPU), and a Data Processing Unit (DPU).

7. The system of claim 1, wherein a first thread is elected to submit the work queue elements, wherein ownership of submitting the work queue elements is transferred from the first thread to a second thread, and wherein the first thread is still enabled to submit a pending work request in response to a predetermined amount of time elapsing even after the ownership of submitting the work queue elements has been transferred to the second thread.

8. The system of claim 7, wherein a communication library is used to determine whether a queue pair is dedicated to a particular thread or is shared among the plurality of threads prior to allocating memory for the plurality of threads.

9. The system of claim 7, wherein the processing device coalesces two or more work queue element submissions from different threads and allocates memory to the two or more work queue element submissions and the threads associated therewith.

10. The system of claim 7, wherein the processing unit checks whether a queue pair associated with a first submission and a queue pair associated with a second submission are shared between a common manager unit from the processing unit.

11. The system of claim 10, wherein the processing unit issues a single work queue element write back to the IO device for both the first submission and the second submission if all threads associated with the first submission and the second submission are shared between the common manager unit.

12. The system of claim 1, wherein the processing unit further enables the plurality of threads to create respective work requests in parallel with one another.

13. A method, comprising:
electing, at a processing unit, a thread from among a plurality of threads to atomically update a queue head pointer;
using the queue head pointer to reserve space in a plurality of memory registers for work queue elements belonging to the plurality of threads; and
submitting, from the processing unit to an input/output (IO) device, the work queue elements.

14. The method of claim 13, wherein a first thread is elected to submit the work queue elements, wherein ownership of submitting the work queue elements is transferred from the first thread to a second thread, and wherein the first thread is still enabled to submit a pending work request in response to a predetermined amount of time elapsing even after the ownership of submitting the work queue elements has been transferred to the second thread.

15. The method of claim 14, further comprising:
determining whether a queue pair is dedicated to a particular thread or is shared among the plurality of threads prior to allocating memory.

16. The method of claim 15, further comprising:
checking whether a queue pair associated with a first submission and a queue pair associated with a second submission are shared between a common manager unit from the processing unit; and
issuing a single work queue element write back to the IO device for both the first submission and the second submission if all threads associated with the first submission and the second submission are shared between the common manager unit.

17. A device, comprising:
a processing unit in communication with an input/output (IO) device, wherein the processing unit supports multiple threads and enables the multiple threads to create work queue elements in parallel and then submit the work queue elements to a common queue pair without requiring a locking of the common queue pair.

18. The device of claim 17, wherein the processing unit is to atomically update a queue head pointer using an elected thread from the multiple threads.

19. The device of claim 18, wherein the queue head pointer reserves space from memory registers for the multiple threads.

20. The device of claim 17, wherein a first thread is elected to submit the work queue elements, wherein ownership of submitting the work queue elements is transferred from the first thread to a second thread, and wherein the first thread is still enabled to submit a pending work request in response to a predetermined amount of time elapsing even after the ownership of submitting the work queue elements has been transferred to the second thread.
